(19) United States
(12) Patent Application Publication
(10) Pub. No.: US 2013/0311311 A1
(43) Pub. Date: Nov. 21, 2013

(54) INGREDIENT BASED FOOD ALLERGEN DETECTION SYSTEM FOR USE BY FOOD SERVICE PROVIDERS

(71) Applicants: Dilip Chopra, Aurora, CO (US); Atul Ahuja, Aurora, CO (US)

(72) Inventors: Dilip Chopra, Aurora, CO (US); Atul Ahuja, Aurora, CO (US)

(21) Appl. No.: 13/951,276

(22) Filed: Jul. 25, 2013

Related U.S. Application Data
(63) Continuation of application No. 13/223,254, filed on Aug. 31, 2011.
(60) Provisional application No. 61/379,267, filed on Sep. 1, 2010.

(51) Int. Cl. G06Q 30/00; G06Q 50/12

(52) U.S. Cl. CPC G06Q 30/018; G06Q 50/12
USPC 705/15

(57) ABSTRACT

An internet based system for analyzing menu items offered by restaurants/food providers to identify menu items which are acceptable to person is disclosed. The system includes an online system having a server in communication with a database of food ingredients for menu items offered by a food provider. The system compares the food ingredients of menu items offered by food providers and compares it with the dietary and/or allergen information of one or more people to identify menu items offered by food provider that are acceptable to the each person.

### CROSS REFERENCE TO RELATED APPLICATION

This application is a continuation application of non-provisional application Ser. No. 13/223,254 filed on Aug. 31, 2011 having the same inventorship therewith. Non-provisional application Ser. No. 13/223,254 claimed the benefit under 35 USC 119(e) of U.S. provisional application No. 61/379,267, filed on Sep. 1, 2010.

### FIELD OF THE INVENTION

The present invention pertains to methods and systems for avoiding foods containing allergens and more particularly to internet based systems and methods for use by mobile users to detect and avoid foods offered by restaurants/bakeries containing allergens and other undesired food ingredients.

### BACKGROUND OF THE INVENTION

Systems and methods are now available that help consumers make various choices when shopping for a place to eat out given geographical areas and preferences. For example, if a consumer desires a certain ethnic cuisine, (Chinese, Italian, Indian, etc) or a certain kind of cuisine (vegetarian, organic etc.), he or she can connect to the internet and specify a geographic area to locate possible restaurants of their choice. With the advent of mobile hand-held devices, one can now able locate places to eat while traveling or away from home. Search engines and websites exist which even list eating establishments that may offer allergy-sensitive menus. For example, certain restaurants present themselves as vegan or gluten-free eating places or allergy-friendly establishments. Such restaurants usually carry limited menu items that may classified as ‘Gluten-Free’ or, ‘Dairy-Free’. Food allergies, however, manifest themselves in a variety of combinations and often are not restricted to simply dairy products or gluten products or other commonly known allergens. For instance, a person may be allergic to all gluten products but may also have an allergy to peas and garbanzo beans, even though peas and garbanzo beans are gluten-free foods. Ingesting an item that may otherwise be labeled as gluten-free but with garbanzo bean ingredients can potentially cause a life-threatening allergic reaction known as an anaphylaxis reaction for certain customers. Similarly, a person who has milk allergies may be allergic to chicken or turkey meat. A restaurant may offer a gluten-free, or a dairy-free menu selection, which in many cases may not be suitable for all customers with a diverse combination of food allergies. Eating out for consumers with such combinations of food allergens can be a very frightening and unpleasant experience especially, if they are trying to locate a place to eat in unfamiliar territories while traveling on business or on vacation. Systems and methods are therefore needed for locating and identifying potential food allergens in ingredients of menu items offered by restaurants or eating places and presenting the information to potential customers.

### SUMMARY OF THE INVENTION

The present invention provides means of locating, discovering, identifying and isolating allergenic (or other undesired) ingredients with the objective of presenting such information to a user and, more importantly, locating such eateries ‘on the go’ such as while driving down the highway or when in unfamiliar geographic areas. The present invention takes the location of the consumer into account, either from customer inputted preferences or through signals obtained via a Global Positioning System or through a cell-phone like device to locate possible eating places that have menu items that accommodate the complex combination of food allergens specific to that individual customer.

The invention describes a system and methodology of presenting menu information for eateries/restaurants after filtering out those items that do not meet the food-allergen criteria of a potential customer and after filtering out places that do not qualify under the pre-set criteria of the customer. The system involves at least one user (typically a potential restaurant customer) who is looking for a place to eat based on his/her food allergy restrictions, at least one participating restaurant/eating house that is willing to share information about its menu offerings (food ingredients), and a central processor/server/data storage device that maintains pertinent information on both the consumer and the restaurant. Such information includes food allergen information on the consumer along with other basic profile information and information about the ingredients of the various items on the restaurant's menu along with other basic profile facts. The system includes a methodology to interpret major food allergens such as milk, gluten, and eggs, etc. and to expand the commonly known nomenclature to the more subtle and not commonly known labels, thereby, enabling a detailed, drilled-down allergen ingredient filtration process for both the restaurant menu items as well as the customer defined restrictions. The system of the present invention also enables access to the filtered restaurant information from the central server/data bank by means of a mobile device such as a cell phone, GPS or GPS-enabled device and is location and ingredient-centric in its functioning.

The internet based system of the present invention in its broadest sense involves analyzing menu items offered by restaurants/food providers in a given locale to identify menu items which are acceptable to a user. The system includes an online system having a server in communication with a database of food ingredients for menu items offered by a plurality of food providers identified by name and location. The system is capable of receiving user dietary and user location information so that the system can compare the food ingredients of menu items offered by food providers in a given locale based upon the user location information with the user dietary information to identify menu items offered by food providers in the given locale that are acceptable to the user.

In a preferred embodiment, a user or potential restaurant customer utilizes a wireless device, preferably a smart phone, to access the online system and input his/her desired location information and dietary information into the system so that the system can then compare the food ingredients of menu items offered by food providers in a given locale with the user dietary information to identify menu items offered by food providers in the given locale that are acceptable to the user based upon the user's dietary information.

A preferred embodiment of the internet based system includes a database for linking user dietary information to associated food ingredients. These user food ingredients can then be compared to the food ingredients of menu items offered by food providers in a given locale to identify menu items offered by food providers in the given locale that are acceptable to the user based upon the user's dietary information.

Another preferred embodiment of the internet based system of the present invention includes a database of select keywords for use when one of the keywords is inputted by an individual inputting provider menu item information into the system. Immediately upon entering a keyword in the database, the system prompts the individual entering the keyword to input additional information regarding a menu item so that the menu item's ingredients can be identified.

The preferred method of the present invention analyzes menu items offered by restaurants/food providers in a desired location to identify menu items which are acceptable to a user. The method preferably utilizes a wireless device such as a smart phone having the capability of connecting to the internet. The preferred method includes the steps of providing an online system having a server in communication with a database of food ingredients for menu items offered by a plurality of food providers identified by name and location and accessing the online system with the wireless device. An individual's dietary information is then inputted into the system with the wireless device. The wireless device is also used to upload desired location information so that inputted menu information of restaurant/food providers in that location can be searched. The final step of the method involves instructing the system via the wireless device to compare the food ingredients of menu items offered by food providers in the desired location with the individual's dietary information to identify menu items offered by food providers in the desired location that are acceptable to the individual based upon the individual's dietary information. This final step is typically carried out by simply pressing or clicking a button on the screen or face of the wireless device.

Another embodiment of the present invention allows a restaurant/provider to input a customer's dietary information into the system at the restaurant/provider's location, thereby allowing the restaurant to identify potentially harmful allergenic menu items for restaurant customers who do not have a wireless device. The system includes an online system having a server in communication with a database of food ingredients for menu items offered by a food provider. The system has the capability of receiving a customer's dietary information so that the system can compare the food ingredients of menu items offered by the food provider with the customer's dietary information to identify menu items offered by the food provider that are acceptable to the customer based upon the customer's dietary information.

Yet another embodiment of the present invention provides a system which allows a provider such as an administrator or food services director of a school cafeteria to create a list of students and their respective dietary information or restrictions wherein each student and his/her respective dietary information/restrictions is represented by a unique code. The code for each student is inputted into the system at the provider's location to generate a list of menu offerings that may or may not be acceptable menu choices given each student's unique set of dietary restrictions as represented by his/her unique code. Under this embodiment, a school administrator/provider may utilize the methodology to create acceptable menu options for students given their unique set of restrictions for several sets of menu options to be offered over several days or months. The system includes an online/local system having a server in communication with a database of food ingredients for menu items offered by the cafeteria/food provider. The system has the capability of receiving the list of student codes representing their respective dietary information/restrictions so that the system can compare the food ingredients of menu items offered by the food provider over a period of time with the student's dietary information/restrictions to identify menu items offered by the food provider that are acceptable based upon the student's dietary information/restrictions.

### BRIEF DESCRIPTION OF THE DRAWINGS

The above and other aspects, features, and advantages of the present invention will become more apparent upon consideration of the following description of preferred embodiments, taken in conjunction with the accompanying drawing figures, wherein:

FIG. 1 depicts a representative network environment suitable for implementing the system and methods of the present invention;

FIG. 2 is a flowchart of the set-up process for restaurant/food providers participating in the system of the present invention.

FIG. 3 is a flowchart of the set-up process for users/potential restaurant customers desiring to use the system of the present invention.

FIG. 4 is a flowchart of the steps a customer makes to obtain information regarding the ingredients in restaurant meals in a desired location or locale.

FIG. 5 is a flowchart describing the process which takes place in a preferred embodiment of the system when a customer decides to execute a search for providers in a given locale after inputting his/her food information/preferences and desired location settings as set forth in the flow charts of FIGS. 3 and 4.

FIG. 6 is a flowchart of the set-up process for real-time food providers such as bakeries participating in the system of the present invention.

FIG. 7 is a block diagram showing the various databases of the preferred embodiment of the present invention which as shown are part of the overall system database SD 16.

### DETAILED DESCRIPTION OF PREFERRED EMBODIMENTS

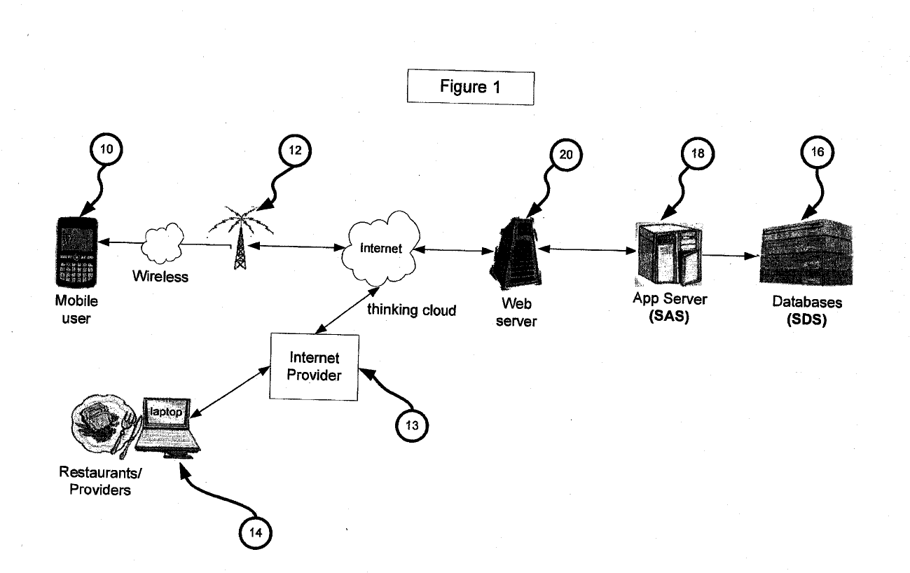

Referring now to the drawings, FIG. 1 sets forth the various internet based communication setups which are used to carry out the methodology of the present invention. As indicated in the summary of the invention above, a potential restaurant customer (PRC also user or customer as sometimes referred to herein) desiring information about the ingredients in restaurant meals in a given locale may connect to the system with a mobile device such as the shown smart-phone 10 or a similar internet accessible device which relies on the services of a cell phone tower 12 to make the internet connection. In addition to cell towers, the present invention contemplates connecting to the internet with all newer technologies such as satellite, Bluetooth, WiMax, radio, 4G, or other wireless data communications technology. In addition to mobile users, restaurants/food providers (RFPs) or providers as sometimes referred to herein representing public food providers such as restaurants, bakeries, hotel operators and other eateries of various kinds may make the internet connection wired or wirelessly through an internet provider 13 with a computer such as the shown laptop computer 14. These providers (or others inputting their menu and restaurant location information into the system) may also use mobile devices. Similarly, PRCs or users could also used wired or wireless computers to access the system. However, due to the volume of provider information input into the system's database SD 16, it is anticipated that most provider information will be inputted using a computer having a full size keyboard and display. In contrast, since the invention contemplates the ability to access the system “on the go” most PRCs or customers will utilize a mobile device such as the illustrated smart phone 10. Notwithstanding the type of device used to access the system, all devices eventually connect to the system's application server (SAS) 18, the system database SD 16 via the internet and a web-server 20. The technology for making these connections is well known to those skilled in the relevant arts pertaining thereto and therefore is not described in detail here.

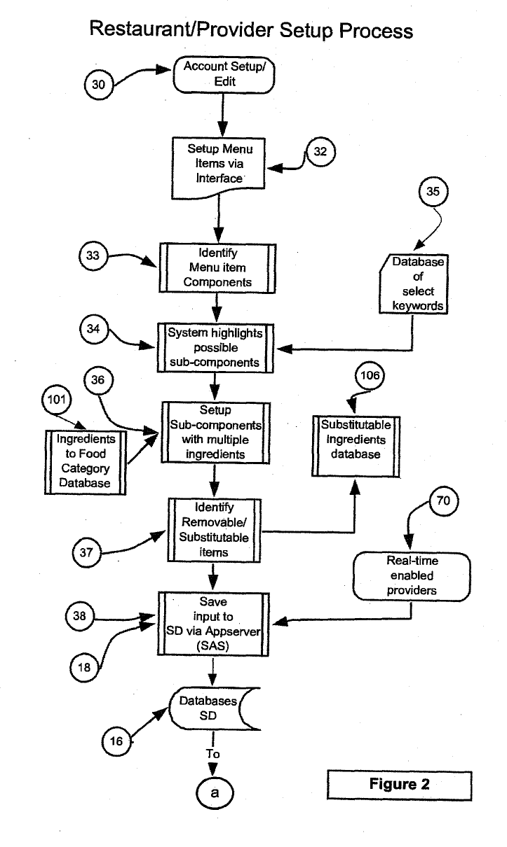

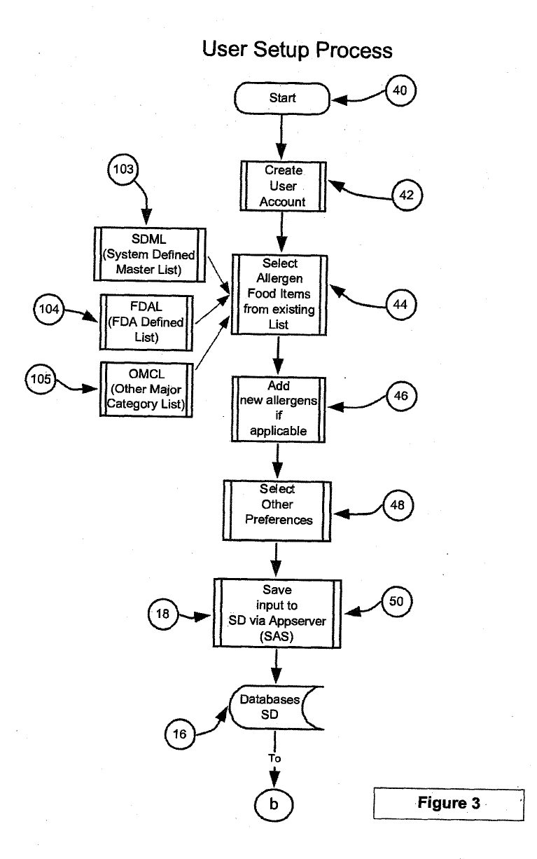

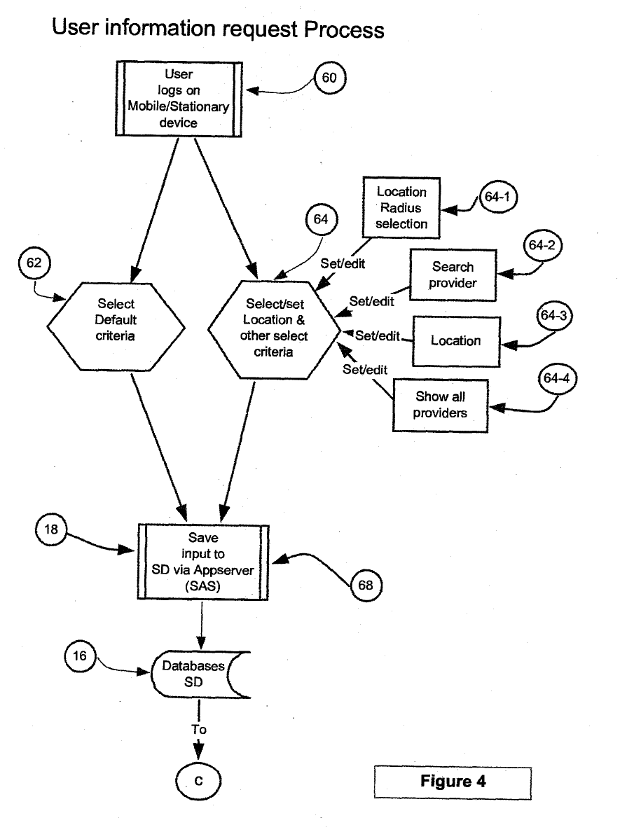

FIGS. 2-4 illustrate sub-processes of a preferred embodiment of the present invention. FIG. 2 sets forth a flow chart of the set-up process for RFPs (providers). FIG. 3 sets forth a flow chart of the set-up process for PRCs (users or customers) and FIG. 4 sets forth a flow chart of the steps a customer makes to obtain information regarding the ingredients in restaurant meals in a given locale.

As shown in FIG. 2, an RFP or provider logs into the system via the internet at 30 to setup an account on the system. After setting up an account, a provider inputs its menu items into the system at 32. A menu item, for example, might be a double deluxe cheeseburger. When the item is inputted, the system assigns the menu item a unique identifier referred to herein as a menu item code. As indicated at 32 the system also enables an existing provider, i.e. a provider already having set up an account and inputted menu items, to modify or edit existing menu items. In any event, after inputting or editing menu items, the system preferably prompts the provider to identify the menu item's components at 33. With the double deluxe cheeseburger menu item mentioned above, the provider might input the following as item components which are also assigned unique codes referred to herein as component codes.

1. Hamburger bun

2. Beef patty

3. Cheese

4. Onions

5. Tomatoes

In addition and in accordance with an important feature of the present invention, the system at 34 for identifies menu item components such as the above hamburger bun, beef patty and cheese components which may contain sub-components that need to be identified. (Sub-components are also assigned unique codes referred to herein as sub-component codes) For example, of the five menu components listed above, the hamburger bun, beef patty and cheese component may contain sub-components that require identification. When this occurs, the system prompts the provider, e.g. in the case of the hamburger bun, to input the bun's sub-components, e.g. whether the bun contain sesame seeds and what type of flour the bun is made from. The system is able to do this with the help of a Database of Select Keywords 35 which is part of the overall system database SD 16. The system recognizes words such as sauces, marinated, special recipe and the like which suggest that the component in question may contain sub-components. The system prompting may be in the form of direct questions to the provider regarding the item in question or it may simply highlight or flash menu items that appear to potentially contain sub-components requiring further identification. In some cases, a sub-component may itself may contain sub-components requiring identification. If so, the system will recognize these sub-components and prompt the provider to input further information regarding the sub-component at 36. When a sub-component (or component or even a menu item) cannot be broken down any further, i.e. does not contain any further sub-components, the sub-component is considered to be a food ingredient as defined herein (or a food) and the code for that food or ingredient is referred herein as an ingredient code. For example, the hamburger bun identified above would not be assigned an ingredient code but its components/sub-components which contain no further components/sub-components would be assigned an ingredient code. Therefore, the hamburger bun's sesame seeds would be assigned an ingredient code as would the wheat flour from which the bun is made. In addition, any other ingredients present in the bun such as salt, preservatives, coloring agents, food chemicals etc. would be assigned ingredient codes. The tomatoes and onions (above components of the double cheeseburger menu item) would also be assigned ingredient codes because they cannot be broken down any further into sub-components. While the bun is not assigned an ingredient code, as indicated above it is assigned a component code. In addition, the double deluxe cheeseburger menu item is not assigned an ingredient code since it contains components but it is assigned a menu item code as indicated above.

In addition, an important feature of the present invention is directed to the provision and maintenance of an Ingredients to Food Category Database 101 which links each ingredient to one or more food categories and vice versa. For example, the wheat flour of the above hamburger bun is an ingredient which database 101 would link to gluten which is one of the nine major allergen categories defined by the FDA. Another example would be whey which could be an ingredient in a hamburger bun. If the provider lists whey as an ingredient in the bun, database 101 would link the bun to the dairy food category since whey is in the dairy food category as defined by the FDA (which is also one of the nine major allergen categories defined by the FDA). The importance of this linking process to the system of the invention will become apparent as the system is described in more detail below.

In addition, at 37 the system prompts the provider to identify whether each inputted component and/or sub-component is removable and/or substitutable. For example, the onions listed above could be identified as removable if the provider desires to make onions removable from the double cheeseburger menu item. Similarly, the cheese identified above could be listed as both removable and substitutable. If listed as substitutable, the system will prompt the provider to identify components that may be substituted for the substitutable component. For example, the cheese listed above may be substituted with soy cheese, again if the provider wishes to make the cheese a substitutable component.

The system is preferably configured to save at 38 all information requested at 33, 34, 36 and 37 as it is inputted to the system database (SD) 16 via the System Application Server 18 (SAS). The substitutable/removable information would be saved to the database of substitutable ingredients 106 which is part of the overall system database SD 16 as shown in FIG. 7. Provider information such as name, location, contact information, website URL and restaurant type (fast food versus fine dining, bakery, hotel, cruise-ship, airline etc) would be saved to a Master Database of Providers at 107. This database is a master listing of all providers whose menu items are available for display to the user. Database 107 is also part of the overall system database SD 16 as shown in FIG. 7. In the alternative, the system could be configured to provide the provider with a save option that the provider could manually execute after inputting the information at 33, 34, 36 and 37.

While it is contemplated that the majority of providers would be using the above outlined steps as part of setting up their menus items, menu item components and their respective ingredients, another likely embodiment might entail the direct transmission of the above information using the operator's customized software that directly links to a provider's database to extract the needed information to automatically create information that is created at 33, 34, 36 and 37 in the above described embodiment.

As mentioned above, FIG. 3 is a flow chart setting forth the steps a potential restaurant customer (PRC) or user carries out in accordance with the present invention to set up an account on the system and input the foods and/or ingredient(s) he/she is allergic to or desires to avoid for whatever reason. As shown, a potential customer logs on to the system at 40 preferably using a mobile device such as the smart phone 10 shown in FIG. 1. The customer then creates a user name and a password at 42. Next, at 44 the user is prompted to input the foods and/or food ingredients that he/she may be allergic to or desires to avoid. The undesired items might be selected from a system defined master list 103 (SDML) of allergens, foods or food ingredients to be avoided or the customer may select from the FDA's list 104 (FDAL) of nine major allergen categories. Alternatively, the customer may select from a list 105 of other major categories (OMCL) which would contain foods to be avoided by followers of these categories/diets such as vegetarian, vegan, Kosher, South Beach, Atkins etc. diets.

The FDA's nine major allergens categories are dairy, gluten, fish, shellfish, tree-nuts, peanuts, egg, corn and soy. Each of these major categories consist of specific allergenic foods. For example, shellfish includes foods such as shrimp, lobster and crab but does not include trout or tuna fish. Such information is maintained by the system in FDA list 104 (FDAL) on the system's database 16. As indicated, if, in addition to selecting from the nine major allergen categories, the customer wants to select ingredients that may or may not be included in the nine FDA defined categories of list 104, the customer may do so by selecting such ingredients from the SDML list 103 or the OMCL list 105. This allows the customer to select any number and any combination of unique selections from hundreds of potentially allergenic foods or food ingredients to be avoided. For example, a customer may choose avocados and chicken from list 103 as additional allergens in addition to choosing dairy and eggs from list 104 or any combinations of foods/ingredients/allergens. Alternatively, a customer desirous of eliminating all meat items from his/her meal may select a diet category called Vegetarian from list 105 and the system would eliminate all products that contain items such as chicken, beef etc that should be avoided by Vegetarians.

If a customer/user finds that a food allergen or undesirable food or ingredient is not listed in any list 103, 104 or 105, a preferred embodiment of the system would allow the customer to make a request to add the undesired allergen or food/ingredient to the master list SDML 103 at 46.

The user may also specify other preferences such as default locations, types of preferred eating places, nutritional preferences such as low calorie food, low sodium food etc. at 48.

The system is also preferably configured at 50 to save all customer information as it is inputted to the system database (SD) 16 via the system application server 18 (SAS). In the alternative, the system could be configured to provide the user with a save option that the user could select after the information is inputted.

FIG. 4 sets forth the steps carried out by a PRC/customer to find food providers (RFP) in a given location selected by the customer and meals offered by the providers which may be consumed by the customer. As shown at 60, the customer logs in to the system preferably using their mobile device such as smart phone 10. The customer would then select his/her preset default settings at 62 or the customer may override the default settings at 64. The default settings would typically include an area setting so that the system when activated searches for providers within a pre-selected area having a radius such as 1 mile, 5 miles etc of the user's current location as determined by the device's GPS locating system (or other locating system used by the device such as a system based on cell tower locations). If the customer wants to change the radius of the area to be searched, he/she can do so as indicated at 64-1 by changing the default area setting from e.g. 1 mile to perhaps 3 miles or whatever distance the customer desires which could include an area having a radius of up to 20 miles or more if desired. The system would also preferably include an option as indicated at 64-2 for confining the search to a single restaurant/provider selected by the customer. In addition, as indicated at 64-3 the system would also preferably provide the customer with the option of changing the location default setting to another specified location or point/location of interest such as a theme park, cruise ship or airline. Accordingly, it will be appreciated that the location could be a fixed location or a moving one. In addition, an option as indicated at 64-4 may also be provided for identifying all restaurant/food providers in a given locale which are not participating providers on the system, i.e. are not system RFPs. In any event, after the user inputs his/her desired location selections, the system saves the selections at 68 to the system database SD 16 via application server 18.

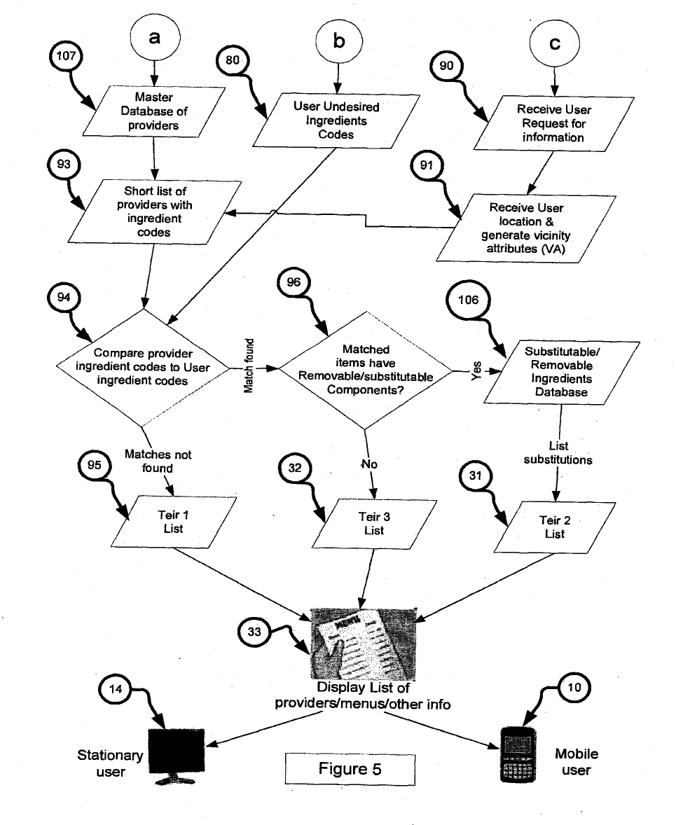

FIG. 5 describes the process which takes place in the preferred embodiment of the system when a customer decides to execute a search for providers in a given locale after inputting his/her food information/preferences and desired location settings as set forth in the flow charts of FIGS. 3 and 4. As indicated at 90, when a customer or user executes such a search for food providers, the system receives the user's location settings also referred to herein as vicinity attributes (VA) from FIG. 4 via arrow c at 91. Based on the VA information received, at 93 the system generates a ‘short-list’ of providers and the food/ingredient codes for food offered by the providers on their menus. Under a typical default location setting, these providers would be those who are located within a preset radius of the user's location as discussed above. The food/ingredient codes 93 for the providers on the short list are then compared at 94 to the ingredient codes 80 for the foods inputted by the user as being undesired or allergens. The results of the comparison are then segregated into two separate categories. The category with no matches between the user codes 80 and the provider codes 93 contains all menu items and menu components/sub-components which are assigned by database 101. These menu items and menu components/sub-components contain no user undesired ingredients and as such should be suitable for the user's consumption. These menu items and menu components/sub-components are preferably organized by provider into a list referred to as the Tier1 list at 95 which is displayable at 33 on the user's mobile device 35 or computer display 14.

The category with matches between the user's codes 80 and the providers' codes 93 is identified at 96. The provider matched codes at 96 are then analyzed by the system to determine if the menu items, components/sub-components which are associated with these codes have a “substitution” or “removable” code attached to them. This information is stored in database 106 as previously described for each menu item, component or sub-component offered by a provider. An example of a ‘substitutable’ item may be cheese, for example, which may be substituted with soy cheese. Another example would be a sesame seed bun which if desired to be made substitutable by a provider could be substituted with plain bun. Those items, components/sub-components that have a ‘substitution’/‘removable’ code are preferably organized into a list at 31 referred as the Tier 2 list. These items are also displayable at 33 on the user's mobile device 35 or computer display 14.

The menu items, components/sub-components associated with provider matched codes at 96 that do not have a “substitution” or “removable” code are foods containing ingredients that the user has inputted as being undesired or allergens. Since these foods cannot be substituted with other foods, they should be avoided by the user. These items are put into a list referred to as the Tier 3 list 32 which depending on user preference may or may not be displayable at 33 to a mobile or stationary user.

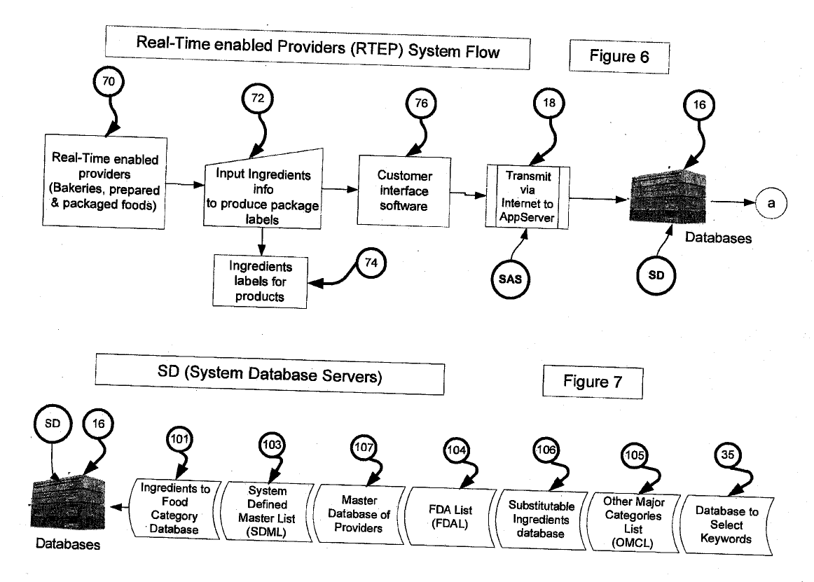

FIG. 6 describes an overall functionality of connecting real-time enabled providers (RTEP) 70 of the System. RTEPs generally represent those providers that are frequently modifying the ingredients in their packaged goods offerings or their offerings are not of a static nature such as prepared food items in retail outlets and bakeries. The RTEPs would generally enter their ingredients information on their in-house/proprietary ingredient labeling systems at 72 in order to produce packaging labels 74. A custom software interface would capture the ingredients database from 72 and save the information via the system application server (SAS) 18 in real-time to the system database server 16 (SD) for eventual processing at via arrow a of FIG. 5.

FIG. 7 sets forth the various databases which are part of the overall system database 16. As shown, SD 16 includes the ingredients to food category database 101, the System Defined Master List (SDML) (103); the FDA Allergen Category Database (104); the other major categories list OMCL 105 and the database of Substitutable Ingredients (106) as previously discussed above. Other databases may be added as needed.

In addition, while the foregoing process is location based in that the user provides his/her location settings/preferences as described in FIG. 4, another preferred embodiment of the present invention contemplates inputting of the user's, i.e. customer's, information by the provider at the provider's physical location. Since the information is inputted by the provider at his/her location there is no need for the user to input his/her location information. This embodiment would be useful for restaurants/providers who want to provide this service for customers who are unable to access the system directly, e.g. for customers who do not have a wireless device or smart phone or in areas where wireless internet access is not available.

Yet another embodiment contemplates implementation of the present invention on the provider's website. In this embodiment, the user's information/preferences would be inputted directly on the provider's website which would then automatically search the provider's menu items and provide the user with a list of menu items meeting the user's preferences. In this embodiment, the provider's website could be linked to a website maintained by the operator of system of the present invention or the provider's website could be provided with system software that would provide the provider's website with the functionality to implement the system independently without any linking to any other website.

Although specific embodiments have been illustrated and described herein, it will be appreciated by those of ordinary skill in the art that any arrangement, which is calculated to achieve the same purpose may be substituted for the specific embodiments shown. This application is intended to cover any adaptation or variation of the invention. It is intended that this invention be limited only by the following claims, and the full scope of equivalents thereof.

We claim:

1. A method of analyzing menu items of a food service provider to determine acceptable items for each member of a group based on any dietary restrictions and/or food allergen information provided for each member of the group, the method comprising the following steps performed by the food service provider:
subscribing to an online application service provider using one or more computing devices operatively connected to a multiuser network;
entering each menu item offered by the food service provider into the one or more databases of the application service provider using the one or more computing devices operatively connected to an online network;
entering the ingredients of each menu item into the one or more databases using the one or more computing devices operatively connected to the online network;
facilitating the entry of information into the one or more databases about each member including the food allergens and/or dietary restrictions of each member;
submitting a query to the application service provider using the one or more computing devices operatively connected to the online network to compare as applicable the food allergens and/or dietary restrictions of each member with the ingredients of each menu item; and
receiving from the online database in response to the query a list for each member of (i) menu items that do not contain as applicable the food allergens and/or dietary restrictions of the member, (ii) menu items that may be consumed by the at least one member with suggested substitute-able ingredients that do not contain the applicable food allergens and/or dietary restrictions of the member and (iii) menu items that should not be consumed by the at least one member.

2. The method of claim 1, wherein the dietary restrictions of each member include food ingredients the member avoids eating.

3. The method of claim 1, further comprising providing the list for each member to the applicable member.

4. The method of claim 1, wherein each member is identified by a unique code.

5. The method of claim 1, wherein the food service provider typically varies its menu offerings based on different days or dates and the method further comprises:
using the lists of the members of the group to generate a set specific menu offerings for particular predetermined dates wherein the set of menu offerings includes menu items acceptable to each of the group members.

6. The method of claim 5 wherein the food service provider comprises a school and the members comprise students.

7. The method of claim 1, wherein said entering the ingredients of each menu item further comprises responding to prompts provided by the application service provider to enter further details about the menu item, associated components of the menu item and as applicable subcomponents of the components.

8. A method of analyzing menu items of a particular food service provider by an application service provider to determine acceptable items for each member of a group based on applicable food allergen and/or dietary information provided for each member of the group, the method comprising the following steps performed by the application service provider:
receiving over a network connection menu information concerning menu items offered by the food service provider and food ingredients contained in the menu items;
storing the menu information in one or more databases on one or more server computers;
receiving over the network connection the applicable allergens and/or dietary restrictions of each member of the group;
storing the food allergens, or dietary restrictions in the one or more databases on one or more server computers;
generating for each member a list of acceptable menu items; and
providing through transmission over the network connection the lists for each member to one or both the food service provider and the member.

9. The method of claim 8, wherein the dietary restrictions of each member include food ingredients the member avoids eating.

10. The method of claim 8, wherein said receiving over network connection menu information concerning menu items further includes transmitting queries to the food service provider concerning ingredients contained in the menu items.

11. The method of claim 8 wherein the food service provider offers different menu options depending on the calendar date; wherein said receiving over a network connection menu information includes receiving specific menu offerings for more than one calendar date; and wherein said generating for each member a list further comprises a listing of acceptable menu items offered by the food service provider for each of the more than one calendar dates.

12. The method of claim 8, wherein the method further comprises generating for each member a list of menu items that contain applicable restricted food allergens and/or dietary ingredients.

13. The method of claim 8, wherein the method further comprises generating for each member a list of menu items that contain applicable restricted food allergens and/or dietary ingredients wherein the restricted food allergens and/or dietary ingredients can be one or both removed and substituted for other ingredients.

14. The method of claim 13, further comprising suggesting possible substitutable ingredients in a menu item that may be acceptable to the member based on the applicable food allergens and/or dietary restrictions of the member.

15. The method of claim 13, further comprising suggesting possible substitutable ingredients for a menu item that may be acceptable to the member based on the applicable food allergens and/or dietary restrictions of the member, the substitutable ingredients being chosen from the food ingredients contained in the menu items.

16. The method of claim 8, wherein said generating for each member a list of acceptable menu items includes (i) for each restricted ingredient determining any aliases or functionally similar ingredients by cross referencing an ingredient to allergen relationship database, and (ii) for each restricted ingredient and identified aliases, searching the menu information for the restricted ingredient and/or identified aliases.
